(19) United States
(12) Patent Application Publication
(10) Pub. No.: US 2022/0013046 A1
(43) Pub. Date: Jan. 13, 2022

(54) VIRTUAL IMAGE DISPLAY SYSTEM, IMAGE DISPLAY METHOD, HEAD-UP DISPLAY, AND MOVING VEHICLE

(71) Applicant: Panasonic Intellectual Property Management Co., Ltd., Osaka (JP)

(72) Inventors: Toshiya MORI, Osaka (JP); Ken'ichi KASAZUMI, Osaka (JP); Satoru TANAHASHI, Osaka (JP); Shigeo KASAHARA, Hyogo (JP)

(73) Assignee: Panasonic Intellectual Property Management Co., Ltd., Osaka (JP)

(21) Appl. No.: 17/484,859

(22) Filed: Sep. 24, 2021

Related U.S. Application Data
(63) Continuation of application No. PCT/JP2020/005835, filed on Feb. 14, 2020.

(30) Foreign Application Priority Data
Mar. 27, 2019 (JP) 2019-061923

(51) Int. Cl. G09G 3/00; G02B 27/01

(52) U.S. Cl. CPC G09G 3/001; G02B 2027/0134; G09G 2380/10; G02B 27/0101

(57) ABSTRACT

A virtual image display system includes an image data producing unit, an image display, and an optical system. The image data producing unit produces, based on image data of a rendering target and position information about a display position of the target, image data to display a virtual image of the target. The image display displays, on a display screen, an image based on the image data to display the virtual image. The display screen is arranged to be tilted with respect to an optical path leading from the display screen to the optical system. The image data of the rendering target includes first image data of a stereoscopic rendering target. The image data producing unit produces, based on the first image data and position information about a display position of the stereoscopic rendering target, second image data to make the user view the stereoscopic rendering target stereoscopically.

### CROSS-REFERENCE TO RELATED APPLICATIONS

The present application is a Bypass Continuation of International Application No. PCT/JP2020/005835 filed on Feb. 14, 2020, which is based upon, and claims the benefit of priority to, Japanese Patent Application No. 2019-061923, filed on Mar. 27, 2019. The entire contents of both applications are incorporated herein by reference.

### TECHNICAL FIELD

The present disclosure generally relates to a virtual image display system, an image display method, a head-up display, and a moving vehicle, and more particularly relates to a virtual image display system for displaying a virtual image, an image display method, a head-up display, and a moving vehicle.

### BACKGROUND ART

JP 2017-142491 A discloses an image display device (virtual image display system) for projecting a virtual image onto a target space. This image display device is implemented as a head-up display (HUD) for vehicles such as automobiles. The HUD is built in the dashboard of a vehicle to project light to produce an image. The projected light is reflected from the windshield of the vehicle toward the vehicle driver who is the viewer of the image. This allows the user (driver) to view the image such as a navigation image as a virtual image and recognize the image as if the virtual image were superimposed on a background image representing a road surface, for example.

With the image display device of JP 2017-142491 A, however, when the user is shifting his or her gaze from a distant target on the road to the virtual image displayed on the display device, it takes some time for him or her to find a focus on the virtual image, thus making the virtual image not easily visible for him or her.

### SUMMARY

The present disclosure provides a virtual image display system, an image display method, a head-up display, and a moving vehicle, all of which are configured or designed to make the virtual image more easily visible for the user.

A virtual image display system according to an aspect of the present disclosure includes an image data producing unit, an image display, and an optical system. The image data producing unit produces, based on image data of a rendering target and position information about a display position of the rendering target, image data to display a virtual image of the rendering target. The image display displays, on a display screen, an image based on the image data to display the virtual image. The optical system condenses, into an eye box, a light beam representing the image displayed on the display screen and thereby makes a user, who has a viewpoint inside the eye box, view the virtual image based on the image displayed on the display screen. The display screen is arranged to be tilted with respect to an optical path leading from the display screen to the optical system. The image data of the rendering target includes first image data of a stereoscopic rendering target. The image data producing unit produces, based on the first image data included in the image data and position information about a display position of the stereoscopic rendering target, second image data to make the user view the stereoscopic rendering target stereoscopically.

An image display method according to another aspect of the present disclosure is a method for displaying the image on the image display of the virtual image display system described above. The image display method includes first, second, third, and fourth processing steps. The first processing step includes acquiring first image data of the stereoscopic rendering target. The second processing step includes acquiring position information about a display position of the stereoscopic rendering target. The third processing step includes producing, based on the first image data and the position information, second image data to make the user view the stereoscopic rendering target stereoscopically. The fourth processing step includes displaying an image based on the second image data on the display screen of the image display.

A head-up display according to still another aspect of the present disclosure includes the virtual image display system described above. The optical system includes a reflective member having a light-transmitting property and configured to reflect incident light toward the eye box. The head-up display makes a user, who has a viewpoint inside the eye box, view the virtual image superimposed on a real space, which is seen by the user through the reflective member.

A moving vehicle according to yet another aspect of the present disclosure includes a moving vehicle body that moves; and the head-up display installed in the moving vehicle body. The reflective member includes a windshield or combiner of the moving vehicle body.

### BRIEF DESCRIPTION OF DRAWINGS

The figures depict one or more implementations in accordance with the present teaching, by way of example only, not by way of limitations. In the figures, like reference numerals refer to the same or similar elements.

FIG. 1 schematically illustrates a virtual image display system according to an exemplary embodiment of the present disclosure;

FIG. 2 schematically illustrates a moving vehicle including the virtual image display system;

FIG. 3 schematically illustrates the virtual image display system;

FIG. 4 illustrates virtual images displayed by the virtual image display system;

FIG. 5 illustrates how to render a stereoscopic image using the virtual image display system;

FIG. 6 is a flowchart showing the procedure of operation of the virtual image display system;

FIG. 7 illustrates virtual images displayed by the virtual image display system; and

FIG. 8 schematically illustrates a virtual image display system according to a first variation of the exemplary embodiment of the present disclosure.

### DETAILED DESCRIPTION

(1) Overview

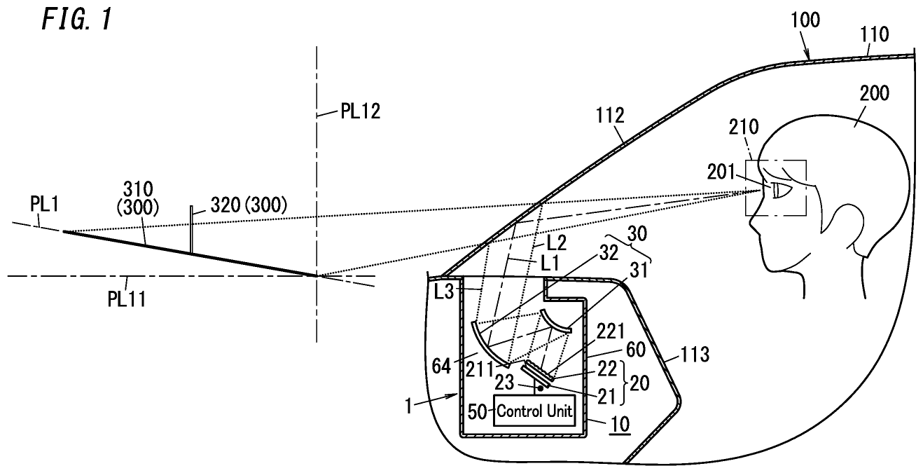

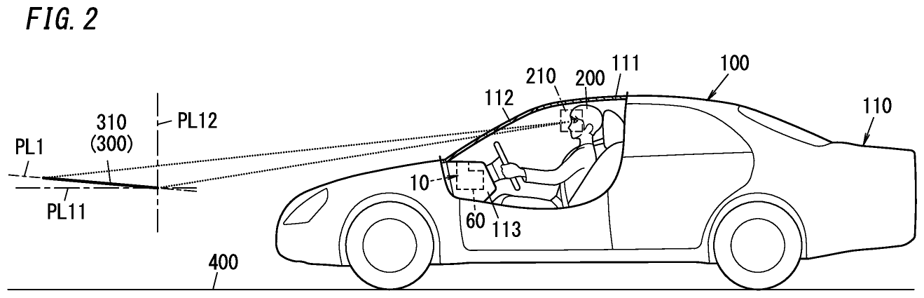

A virtual image display system 10 according to an exemplary embodiment may be used in, for example, an automobile 100 as an exemplary moving vehicle as shown in FIGS. 1 and 2.

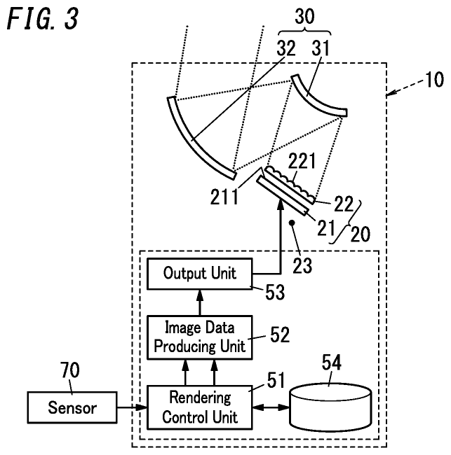

As shown in FIGS. 1 and 3, the virtual image display system 10 includes an image data producing unit 52 (see FIG. 3), an image display unit 20, and an optical system 30. The image data producing unit 52 produces, based on first image data of a stereoscopic rendering target and position information about a display position of the stereoscopic rendering target, second image data to make the user 200 view the stereoscopic rendering target stereoscopically. The image display unit 20 displays, on a display screen 221, an image based on the second image data. The optical system 30 condenses, into an eye box 210, a light beam representing the image displayed on the display screen 221 and thereby makes a user, who has a viewpoint 201 inside the eye box 210, view the virtual image 310 based on the image displayed on the display screen 221. The display screen 221 is arranged to be tilted with respect to an optical path L1 leading from the display screen 221 to the optical system 30.

In other words, the image data producing unit 52 produces, based on image data of a rendering target and position information about a display position of the rendering target, image data to display a virtual image of the rendering target. The image display unit 20 displays, on a display screen, an image based on the image data to display the virtual image. The optical system 30 condenses, into the eye box 210, a light beam representing the image displayed on the display screen 221 and thereby makes the user, who has a viewpoint 201 inside the eye box 210, view the virtual image 310 based on the image displayed on the display screen 221. The display screen 221 is arranged to be tilted with respect to an optical path L1 leading from the display screen 221 to the optical system 30. The image data of the rendering target includes first image data of a stereoscopic rendering target. The image data producing unit 52 produces, based on the first image data included in the image data and position information about a display position of the stereoscopic rendering target, second image data to make the user view the stereoscopic rendering target stereoscopically.

The virtual image display system 10 may be used in, for example, a head-up display 1 to be installed in an automobile 100. That is to say, the head-up display 1 according to this embodiment includes the virtual image display system 10. In this head-up display 1, the optical system 30 thereof includes a reflective member (e.g., a windshield 112). The reflective member has a light-transmitting property and reflects incident light toward the eye box 210. This makes the user 200, who has a viewpoint inside the eye box 210, view the virtual image 310 (300) superimposed on a real space, which is seen by the user through the reflective member.

The virtual image display system 10 according to this embodiment may be used in, for example, the head-up display 1 to be installed in the automobile 100 to present, within the user's 200 sight, various types of driver assistance information including information about the velocity and conditions of the automobile 100 and driving information. Examples of the driving information about the automobile 100 include navigation-related information presenting proposed traveling routes and adaptive cruise control (ACC) related information for use to keep the traveling velocity and the distance between the vehicles constant. In this case, the virtual images 300 presented by the virtual image display system 10 include a virtual image 310 to be displayed on a plane PL11 parallel to a traveling surface 400 of the automobile 100 and a virtual image 320 to be displayed on a plane PL12 perpendicular to the traveling surface 400. The navigation-related information presenting proposed traveling routes and the ACC related information are suitably displayed along the traveling surface 400 and presented using the virtual image 310. On the other hand, the information about the velocity and conditions of the automobile 100 is suitably displayed on the plane PL12 perpendicular to the traveling surface 400 and presented using the virtual image 320. In addition, since the types of information displayed by the virtual image display system 10 are determined in advance, the image data of the virtual images 300 displayed by the virtual image display system 10 is stored in advance in a storage unit 54. That is to say, third image data about the virtual image 310 as a plane rendering target and the first image data about the virtual image 320 as the stereoscopic rendering target are stored in advance in the storage unit 54. Thus, the image data producing unit 52 produces, based on the first image data about the virtual image 320 as the stereoscopic rendering target and position information about a display position of the virtual image 320 in a target space where the virtual image 320 needs to be displayed, the second image data to make the user view the virtual image 320 stereoscopically. In addition, the image data producing unit 52 also produces, based on the third image data about the virtual image 310 as the plane rendering target and position information about a display position of the virtual image 310, fourth image data to make plane rendering of the virtual image 310.

In this case, the optical system 30 condenses, into the eye box 210, a light beam representing the image displayed on the display screen 221 by reflecting and/or refracting the light beam representing the image displayed on the display screen 221. In the embodiment to be described below, the optical system 30 includes: a first mirror 31 for reflecting the light beam emerging from the display screen 221 of the image display unit 20; a second mirror 32 for reflecting the light beam that has been reflected from the first mirror 31; and a windshield 112 for reflecting, toward the eye box 210, the light beam that has been reflected from the second mirror 32. In this embodiment, the optical system 30 is implemented as a combination of the first mirror 31 such as a convex mirror; the second mirror 32 such as a concave mirror; and the windshield 112. However, the configuration of the optical system 30 may be changed as appropriate. That is to say, the combination of optical members (such as lenses and mirrors) that form the optical system 30 may be changed as appropriate according to the size of the display screen 221, a zoom power, a viewing distance, and other parameters. The first mirror 31 does not have to be a convex mirror but may also be a plane mirror or a concave mirror. The second mirror 32 does not have to be a concave mirror but may also be a plane mirror or a convex mirror, for example. Furthermore, the optical system 30 may also be a combination of three or more mirrors or a combination of multiple lenses as well. Alternatively, the optical system 30 may even be configured as a single optical member (such as a single lens or a single mirror).

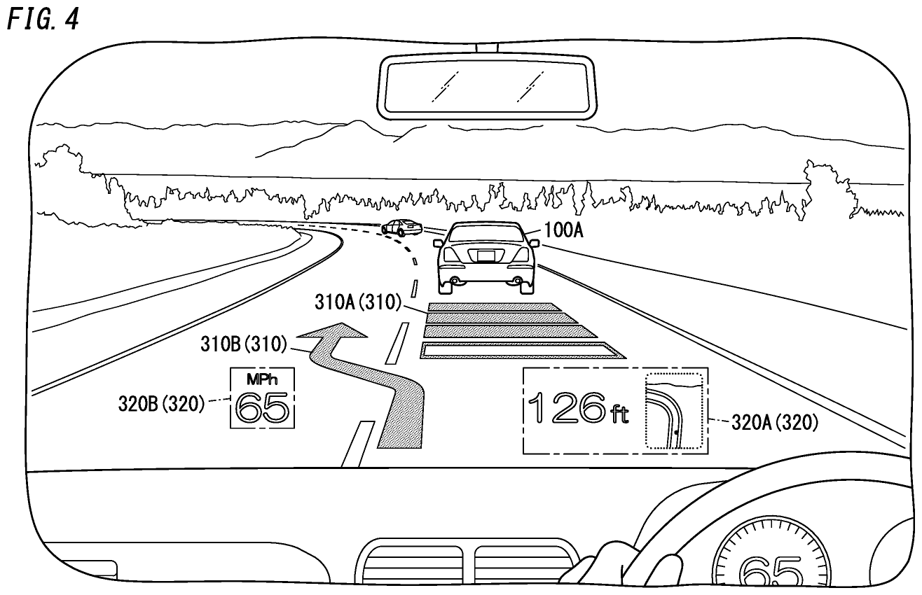

A light beam representing the image displayed on the display screen 221 of the image display unit 20 is condensed by the optical system 30 into the eye box 210. This allows the user 200 who has a viewpoint 201 inside the eye box 210 to view the image projected by the optical system 30. That is to say, the user 200 may view virtual images 310, 320 (see FIGS. 1 and 4) based on the image displayed on the display screen 221 by viewing the image that has been magnified by the optical system 30. In other words, the virtual images 310, 320 herein refer to images produced, when a light beam emerging from the image display unit 20 is reflected from the windshield 112 of the optical system 30, by the reflected light beam as if an object were actually present in the viewing direction of the user 200. Since the windshield 112 has a light-transmitting property, the head-up display 1 makes the user 200 who has a viewpoint inside the eye box 210 view the virtual images 310, 320 (see FIG. 4) superimposed on a real space which is seen by the user through the reflective member.

In the virtual image display system 10 according to this embodiment, the image display unit 20 is arranged such that the display screen 221 thereof is tilted with respect to the optical path L1 leading from the display screen 221 to the optical system 30. As used herein, if the display screen 221 is tilted with respect to the optical path L1, it means that a normal to the display screen 221 obliquely intersects with a line parallel to the optical path L1. In the example illustrated in FIG. 1, the image display unit 20 is arranged such that the distance from the first mirror 31 to an upper end portion of the image display unit 20 is different from the distance from the first mirror 31 to a lower end portion of the image display unit 20 (i.e., such that the image display unit 20 is tilted with respect to the first mirror 31 (optical system 30)). In this case, as the image display unit 20 is brought closer to a focal point 23 of the optical system 30 including the first mirror 31 and the second mirror 32, the viewing distance to the virtual image increases. On the other hand, as the image display unit 20 is arranged more distant from the focal point 23 (i.e., brought closer to the optical system 30), the viewing distance to the virtual image decreases. In this embodiment, the image display unit 20 is arranged between the optical system 30 and the focal point 23 of the optical system 30. The image display unit 20 is arranged such that when the image displayed on the display screen 221 is projected toward the user 200 through the optical system 30, the distance between one end portion (e.g., the lower end portion) of the display screen 221, corresponding to an upper end portion of the image, and the eye box 210 becomes longer than the distance between the other end portion (e.g., the upper end portion) of the display screen 221, corresponding to the lower end portion of the image, and the eye box 210. This causes the virtual image 310 as the plane rendering target to be projected onto a plane PL1 tilted with respect to the plane PL11 parallel to the traveling surface 400 (see FIG. 2) on which the automobile 100 is running and the plane PL12 perpendicular to the traveling surface 400. This allows giving a natural sense of distance to the virtual image 310 as the plane rendering target, thus increasing the degree of visibility of the virtual image 310. Alternatively, the plane PL1 may be made substantially parallel to the plane PL11 by changing the arrangement of the image display unit 20 and the optical system 30.

On the other hand, the virtual image 320 as the stereoscopic rendering target is displayed at a desired display position along the plane PL12 perpendicular to the traveling surface 400 of the automobile 100. This allows the user 200 to acquire necessary information based on the virtual image 320 displayed.

The virtual image display system 10 according to this embodiment may display the virtual image 310 that gives a natural sense of distance by displaying an image on the display screen 221 of the image display unit 20. Thus, there is no need for the image data producing unit 52 to perform any special processing for producing the third image data to display the virtual image 310. Thus, the image data producing unit 52 has only to produce the second image data to display the virtual image 320 as the stereoscopic rendering target. This achieves the advantage of reducing the processing load of producing the image data. This allows the virtual image display system 10 according to this embodiment to increase the degree of visibility of the image while lightening the processing load of producing the image data.

(2) Details

Next, a virtual image display system 10 according to this embodiment will be described in detail with reference to the accompanying drawings.

(2.1) Configuration

As shown in FIGS. 1 and 3, the virtual image display system 10 according to this embodiment includes the image display unit 20, the optical system 30, and a control unit 50. The virtual image display system 10 further includes a housing 60 for housing the image display unit 20, the optical system 30, and the control unit 50 therein.

The virtual image display system 10 according to this embodiment is installed in the moving vehicle body 110 of the automobile 100 as an exemplary moving vehicle. That is to say, the moving vehicle (automobile 100) includes the moving vehicle body 110 to move, and the virtual image display system 10 installed in the moving vehicle body 110. The reflective member provided for the virtual image display system 10 may be implemented as, for example, a windshield 112 but may also be implemented as a combiner provided for the moving vehicle body 110.

Next, the housing 60, the image display unit 20, the optical system 30, and the control unit 50 as respective constituent elements of the virtual image display system 10 will be described one by one with reference to the accompanying drawings.

(2.1.1) Housing

The housing 60 may be a molded product of a synthetic resin, for example. The housing 60 may be formed in the shape of a box with an internal chamber 64. In the internal chamber 64, housed are the image display unit 20, the optical system 30, the control unit 50, and other members.

The housing 60 is installed in a dashboard 113 of the moving vehicle body 110. The light beam reflected from the second mirror 32 of the optical system 30 passes through an opening provided through the upper surface of the housing 60 to irradiate the windshield 112. Then, the light beam is reflected from the windshield 112 and condensed into the eye box 210.

(2.1.2) Image Display Unit

The image display unit 20 includes a display device 21 and a lens array 22 arranged on the display screen 211 of the display device 21. The image display unit 20 has the capability of displaying a stereoscopic image by the light field method, according to which an object in an image captured is made to look stereoscopic by reproducing light beams emerging in a plurality of directions from the object.

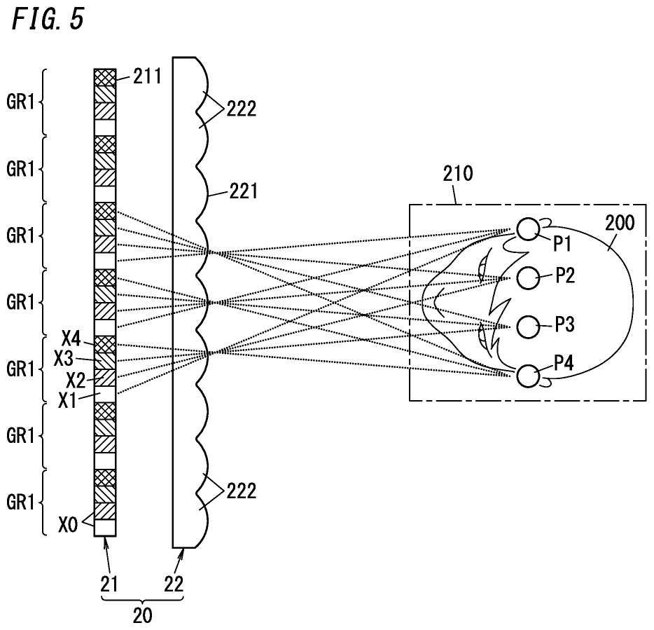

The display device 21 is housed in the internal chamber 64 such that the display screen 211 faces the first mirror 31. The display screen 211 of the display device 21 has a shape (e.g., a rectangular shape) corresponding to the range of the image to be projected toward the user 200 (i.e., the shape of the windshield 112). On the display screen 211 of the display device 21, a plurality of pixels X1-X4 (see FIG. 5) are arranged to form an array. The plurality of pixels X1-X4 of the display device 21 emits light beams under the control of the control unit 50. As a result, an image to be displayed on the display screen 211 is formed by the light beams emerging from the display screen 211 of the display device 21. The display device 21 may be implemented as, for example, a liquid crystal display or an organic electroluminescent (EL) display, for example.

On the display screen 211 of the display device 21, arranged is the lens array 22. In this case, the surface of the lens array 22 may serve as the display screen 221 of the image display unit 20. The lens array 22 includes a plurality of lenses 222 (see FIG. 5) which are arranged to form an array. Each of the plurality of lenses 222 of the lens array 22 is associated with a plurality of (e.g., four) pixels X1-X4 of the display device 21. In FIG. 5, each set of four pixels X1-X4, indicated by a bracket GR1, is associated with the same lens 222 out of the plurality of lenses 222.

In the example illustrated in FIG. 5, four viewpoints P1-P4 are set horizontally inside the eye box 210. Onto the viewpoint P1, light beams coming from a plurality of pixels X1 of the display device 21 are focused through a plurality of lenses 222. Onto the viewpoint P2, light beams coming from a plurality of pixels X2 of the display device 21 are focused through a plurality of lenses 222. Onto the viewpoint P3, light beams coming from a plurality of pixels X3 of the display device 21 are focused through a plurality of lenses 222. Onto the viewpoint P4, light beams coming from a plurality of pixels X4 of the display device 21 are focused through a plurality of lenses 222. In this embodiment, the lens array 22 is arranged in front of the display device 21. However, this is only an example and should not be construed as limiting. Alternatively, a light control member through which a plurality of pinholes are opened to form an array may be arranged, instead of the lens array 22, in front of the display device 21.

To display the virtual image 320 as the stereoscopic rendering target, the control unit 50 has an image, based on the second image data to display the virtual image 320, displayed on the display screen 211 of the display device 21. Specifically, the control unit 50 makes four sets of pixels X1, X2, X3, X4 corresponding to the viewpoints P1, P2, P3, P4, respectively, and selected from the plurality of pixels associated with a position where the virtual image 320 is to be projected, display the image based on the second image data. As a result, the light beams, emitted from the set of pixels X1 corresponding to the viewpoint P1, cause a virtual image 320, based on the image displayed at the plurality of pixels X1, to be projected onto the viewpoint P1. In the same way, the light beams, emitted from the set of pixels X2 corresponding to the viewpoint P2, cause a virtual image 320, based on the image displayed at the plurality of pixels X2, to be projected onto the viewpoint P2. The light beams, emitted from the set of pixels X3 corresponding to the viewpoint P3, cause a virtual image 320, based on the image displayed at the plurality of pixels X3, to be projected onto the viewpoint P3. The light beams, emitted from the set of pixels X4 corresponding to the viewpoint P4, cause a virtual image 320, based on the image displayed at the plurality of pixels X4, to be projected onto the viewpoint P4.

In this case, when the images forming the virtual image 320 based on the second image data are displayed at the plurality of pixels corresponding to the display position of the virtual image 320 on the display screen 221 of the image display unit 20, light beams representing these images are condensed into the eye box 210 through the lens array 22 and the optical system 30. For example, when the user's 200 right eye is located at the viewpoint P2 and his or her left eye is located at the viewpoint P3, the light beams emerging from the pixels corresponding to the viewpoint P2 are projected onto his or her right eye and the light beams emerging from the pixels corresponding to the viewpoint P3 are projected onto his or her left eye. Consequently, the images forming the virtual image 320 that reproduces the parallax between the user's 200 right and left eyes are projected onto his or her right and left eyes, thus making the user 200 recognize the images as if the virtual image 320 were rendered stereoscopically.

On the other hand, to display the virtual image 310 as the plane rendering target, the control unit 50 has an image, based on the fourth image data to display the virtual image 310, displayed on the display screen 211 of the display device 21. That is to say, the control unit 50 has the image based on the fourth image data displayed on a plurality of pixels corresponding to the position to which the virtual image 310 is projected. In other words, the control unit 50 has the image based on the fourth image data displayed by using all of a plurality of pixels corresponding to the position to which the virtual image 310 is projected and associated with the viewpoints P1-P4. Note that the light beams emerging from the plurality of pixels where the image based on the fourth image data is displayed also pass through the lens array 22. Thus, for example, the light beams emerging from the pixels corresponding to the viewpoint P1 are incident on the viewpoint P1 but the light beams emerging from the pixels corresponding to the viewpoints P2-P4 are not incident on the viewpoint P1. For example, when the user's 200 right eye is located at the viewpoint P2 and his or her left eye is located at the viewpoint P3, the light beams emerging from the pixels corresponding to the viewpoint P2 are projected onto his or her right eye and the light beams emerging from the pixels corresponding to the viewpoint P3 are projected onto his or her left eye. This allows the user 200 to view the virtual image 310 based on the light beams projected from the pixels corresponding to the viewpoint P2 and the light beams projected from the pixels corresponding to the viewpoint P3. In this case, the virtual image 310 is projected onto the plane PL1 defined along the traveling surface 400 of the automobile 100 and is viewed with a natural sense of distance. This reduces the difference in the sense of distance between the virtual image 310 and the background of the virtual image 310, thus making the virtual image 310 displayed more easily visible.

As can be seen, on the display screen 221 of the image display unit 20, the image based on the second image data is displayed at the plurality of pixels corresponding to the display position of the virtual image 320 and the image based on the fourth image data is displayed at the plurality of pixels corresponding to the display position of the virtual image 310. The image displayed on the display screen 211 of the display device 21 is viewed by the user 200 who has a viewpoint inside the eye box 210 through the lens array 22 and the optical system 30. This allows the user 200 to view the virtual image 310 superimposed along the traveling surface 400 of the automobile 100 and the virtual image 320 rendered stereoscopically along the plane PL12 perpendicular to the traveling surface 400.

Note that the light field method is not the only method allowing the image display unit 20 to display the virtual image 320 of the stereoscopic rendering target stereoscopically. Alternatively, the image display unit 20 may also adopt a parallax method, which allows the user 200 to view a virtual image 320 of the stereoscopic rendering target by projecting a pair of images with a parallax onto the user's 200 right and left eyes, respectively.

(2.1.3) Optical System

The optical system 30 condenses the light beam emerging from the display screen 221 of the image display unit 20 into the eye box 210. In this embodiment, the optical system 30 includes: the first mirror 31, which may be a convex mirror, for example; the second mirror 32, which may be a concave mirror; and the windshield 112.

The first mirror 31 reflects the light beam emerging from the image display unit 20 to make the light beam incident on the second mirror 32.

The second mirror 32 reflects the light beam, which has been incident thereon from the first mirror 31, toward the windshield 112.

The windshield 112 reflects the light beam, which has been incident thereon from the second mirror 32, to make the light beam incident into the eye box 210.

In this embodiment, the display screen 221 of the image display unit 20 is arranged to be tilted with respect to an optical path L1 (see FIG. 1) leading from the display screen 221 to the optical system 30. The optical path L1 is the optical path of a light beam emerging from a center of the display screen 221 (e.g., a point corresponding to the center of the rectangular display screen 221) toward the optical system 30. Meanwhile, an optical path L2 indicated by the dotted line in FIG. 1 is the optical path of a light beam emerging from one end portion of the display screen 221 (an end portion corresponding to an upper end portion of the image viewed by the user 200; the lower end portion in FIG. 1, for example) to be condensed into the eye box 210 through the optical system 30. Furthermore, an optical path L3 indicated by the dotted line in FIG. 1 is the optical path of a light beam emerging from the other end portion of the display screen 221 (an end portion corresponding to a lower end portion of the image viewed by the user 200; the upper end portion in FIG. 1, for example) to be condensed into the eye box 210 through the optical system 30. In this embodiment, the display screen 221 of the image display unit 20 is tilted with respect to the optical path L1. In the example illustrated in FIG. 1, the image display unit 20 is arranged to be tilted with respect to the first mirror 31 (optical system 30) such that the distance from the first mirror 31 to an upper end portion of the image display unit 20 is different from the distance from the first mirror 31 to a lower end portion of the image display unit 20. More specifically, the image display unit 20 is arranged such that with respect to a focal point 23 of the optical system 30 including the first mirror 31 and the second mirror 32, a first interval between one end portion (i.e., the lower end portion in FIG. 1) of the display screen 221 of the image display unit 20 and the focal point 23 becomes shorter than a second interval between the other end portion (i.e., the upper end portion in FIG. 1) of the display screen 221 of the image display unit 20 and the focal point 23. In this case, as the image display unit 20 is brought closer to the focal point 23 of the optical system 30 including the first mirror 31 and the second mirror 32, the viewing distance to the virtual image increases. On the other hand, as the image display unit 20 is arranged more distant from the focal point 23 (i.e., brought closer to the optical system 30), the viewing distance to the virtual image decreases. Thus, the virtual image 310 to be plane-rendered based on the image displayed on the display screen 221 is viewed by the user 200 as a virtual image 310, of which the display position appears to vary depending on how far the upper edge of the virtual image 310 is such that the uppermost part of the virtual image 310 looks to the user's 200 eyes as if that part were displayed at a position most distant from his or her eye box 210. Consequently, the virtual image 310 to be plane-rendered is projected onto a plane PL1 which is tilted with respect to both a first plane PL11 parallel to the traveling surface 400 where the automobile 100 equipped with the virtual image display system 10 is running and a second plane PL12 perpendicular to the traveling surface 400. Consequently, the virtual image display system 10 may have the virtual image 310 as the plane rendering target displayed along the traveling surface 400 with a natural sense of distance, thus reducing the difference in the sense of distance between the virtual image 310 and the background of the virtual image 310 and thereby making the virtual image 310 displayed more easily visible. In this embodiment, the image display unit 20 is arranged between the optical system 30 and the focal point 23 of the optical system 30.

(2.1.4) Control Unit

The control unit 50 includes a computer system, for example. The computer system may include one or more processors and one or more memories as principal hardware components. The functions of the control unit 50 (e.g., the functions of a rendering control unit 51, the image data producing unit 52, and an output unit 53) may be performed by making the one or more processors execute a program stored in the one or more memories or the storage unit 54 of the computer system. The program may be stored in advance in the one or more memories or the storage unit 54 of the computer system. Alternatively, the program may also be downloaded through a telecommunications line or be distributed after having been recorded in some non-transitory storage medium such as a memory card, an optical disc, or a hard disk drive, any of which is readable for the computer system.

The storage unit 54 may be implemented as, for example, a non-transitory storage medium such as a programmable nonvolatile semiconductor memory. The storage unit 54 stores, for example, a program to be executed by the control unit 50. In addition, the virtual image display system 10 according to this embodiment is used to present, within the user's 200 sight, driver assistance information including information about the velocity and conditions of the automobile 100 and driving information. Thus, the type of the virtual images 300 displayed by the virtual image display system 10 are determined in advance. The image data to display the virtual images 300 (including the virtual image 310 as the plane rendering target and the virtual image 320 as the stereoscopic rendering target) is stored in advance in the storage unit 54.

The rendering control unit 51 receives detection signals from various sensors 70 installed in the automobile 100. The sensors 70 may be sensors for detecting various types of information for use in an advanced driver assistance system (ADAS), for example. The sensors 70 include at least one sensor selected from the group consisting of: sensors for measuring the velocity, temperature, residual fuel and other parameters of the automobile 100; an image sensor for shooting video presenting the surroundings of the automobile 100; and a milli-wave radar and a light detection and ranging (LiDAR) sensor for detecting objects present around the automobile 100.

The rendering control unit 51 acquires, in accordance with the detection signals supplied from the sensors 70, a single or multiple items of image data for displaying information about the detection signals from the storage unit 54. In this case, when multiple types of information are displayed on the image display unit 20, the rendering control unit 51 acquires multiple items of image data for displaying the multiple types of information. In this case, the multiple items of the image data acquired by the rendering control unit 51 may include only the first image data of the stereoscopic rendering virtual image 320, only the third image data of the plane rendering virtual image 310, or both the first image data and the third image data in combination. In addition, the rendering control unit 51 also obtains, in accordance with the detection signals supplied from the sensors 70, position information about the display position of the virtual image in a target space where the virtual image is displayed. Then, the rendering control unit 51 outputs the image data of the virtual image(s) 300 to display (namely, the virtual image 320 to be rendered stereoscopically and/or the virtual image 310 to be rendered as a plane image) and the position information to the image data producing unit 52.

The image data producing unit 52 produces, based on the image data and position information provided by the rendering control unit 51, image data for displaying the virtual image(s) 300 to display. To display the virtual image 320 to be rendered stereoscopically, the image data producing unit 52 produces the second image data to have the same image displayed at the pixels X1-X4 corresponding to the viewpoints P1-P4, respectively, among the plurality of pixels corresponding to the display position of the virtual image 320. On the other hand, to display the virtual image 310 to be rendered as a plane image, the image data producing unit 52 produces the fourth image data to have the image to form the virtual image 310 displayed at the plurality of pixels corresponding to the display position of the virtual image 310.

The output unit 53 outputs the second image data and/or the fourth image data that has/have been produced by the image data producing unit 52 to the display device 21 to have an image based on the second image data and/or the fourth image data displayed on the display screen 211 of the display device 21. A light beam representing the image displayed on the display screen 211 is condensed into the eye box 210 through the lens array 22 and the optical system 30, thus making the user 200 view the virtual image 320 to be rendered stereoscopically and/or the virtual image 310 to be rendered as a plane image.

(2.2) Operation

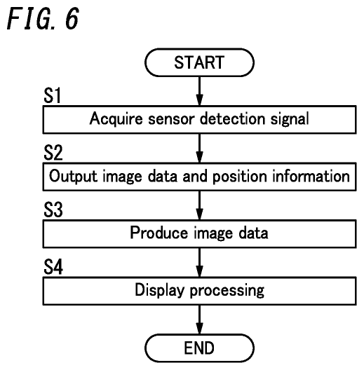

Next, it will be described with reference to the flowchart shown in FIG. 6 how the virtual image display system 10 according to this embodiment operates.

For example, when receiving a control signal, instructing the virtual image display system 10 to start operating, from an electronic control unit (ECU) of the automobile 100 while receiving power supplied from a battery of the automobile 100, the virtual image display system 10 starts operating.

For example, when receiving a control signal from the ECU of the automobile 100, the control unit 50 acquires a detection signal at regular intervals from, for example, any of the sensors 70 provided for the automobile 100 (in S1). Note that the control unit 50 does not have to acquire the detection signal at regular intervals from the sensor 70. Alternatively, the control unit 50 may also be configured to acquire the detection signal from the sensor 70 when finding the detection signal changed.

On acquiring the detection signal from the sensor 70, the rendering control unit 51 of the control unit 50 acquires, from the storage unit 54, the image data of the virtual image(s) 300 (namely, the first image data of the virtual image 320 to be rendered stereoscopically and/or the third image data of the virtual image 310 to be rendered as a plane image) to display the information represented by the detection signal. In addition, the rendering control unit 51 also acquires, in accordance with the detection signal from the sensor 70, position information about the display position(s) of the virtual image(s) 300. Then, the rendering control unit 51 outputs the image data of the virtual image(s) 300 to display the information represented by the detection signal from the sensor 70 and the position information to the image data producing unit 52 (in S2).

For example, if the detection signal supplied from the sensor 70 represents information about the distance to another automobile 100A (hereinafter referred to as a “leading automobile 100A”) running ahead of its own automobile 100, then the rendering control unit 51 outputs the image data of a virtual image 310A (see FIG. 4) indicating the distance to the leading automobile 100A and a virtual image 310B (see FIG. 4) indicating a suggested traveling course and the position information. In this case, the virtual image 310A to be superimposed on the view of the traveling surface 400 to indicate the distance to the leading automobile 100A and the virtual image 310B to be superimposed on the view of the traveling surface 400 to indicate a suggested traveling course to avoid the leading automobile 100A are virtual images to be rendered as plane images. That is to say, the rendering control unit 51 outputs the image data of the virtual images 310A, 310B to be superimposed on the view of the traveling surface 400 and position information indicating their display positions to the image data producing unit 52. In addition, the rendering control unit 51 also outputs, to the image data producing unit 52, the image data of another virtual image 320A to be rendered stereoscopically as a combination of a numerical value and a schematic in order to indicate the distance to the leading automobile 100A and the suggested traveling course to avoid the leading automobile 100A and its position information.

On the other hand, if the detection signal supplied from the sensor 70 represents information about the velocity of the automobile 100, then the rendering control unit 51 outputs, to the image data producing unit 52, the image data of another virtual image 320B to be rendered stereoscopically as a numerical value indicating the velocity.

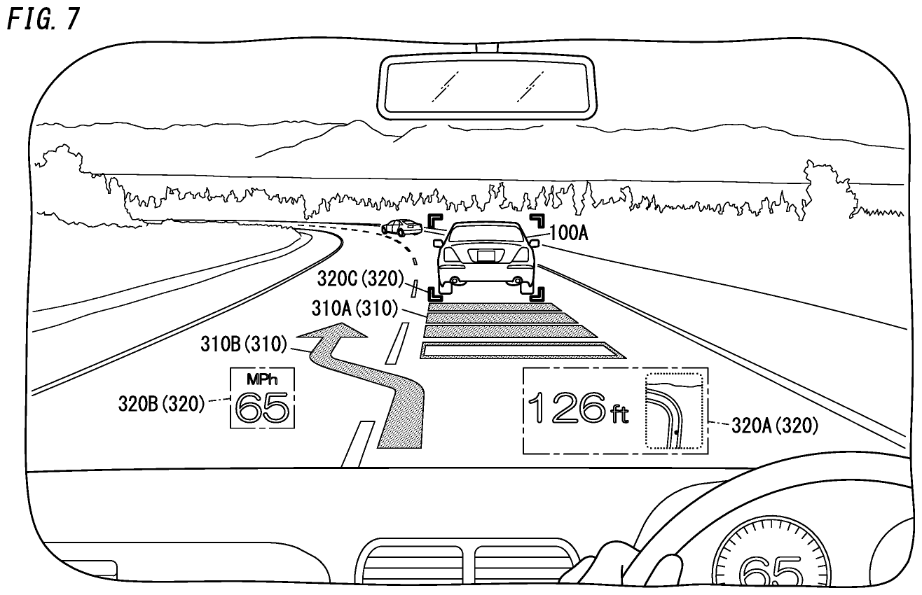

Note that the virtual images 320A, 320B are virtual images to display a first target such as a meter or a map, of which the display position remains located at a predetermined distance from the eye box 210, irrespective of the surrounding circumstances. However, the stereoscopic rendering target may include a second target. The second target is a target, of which the display position is located at a distance, varying according to the surrounding circumstances, from the eye box 210. The second target may be, for example, a marker indicating the leading automobile 100A. The virtual image display system 10 displays a virtual image 320C to indicate a marker surrounding the leading automobile 100A as shown in FIG. 7. In this case, the image data producing unit 52 changes the display position of the marker (second target) indicating the leading automobile 100A according to the distance to the leading automobile 100A. In other words, the distance from the display position of the second target to the eye box 210 varies depending on the result of measurement made by the sensor 70 for measuring the surrounding circumstances (such as the distance to the leading automobile 100A). This allows the virtual image 320 representing the second target to be displayed at a desired position.

On receiving the image data of the virtual image(s) 300 to display (namely, the virtual image 310 to be rendered as a plane image and/or the virtual image 320 to be rendered stereoscopically) and the position information from the rendering control unit 51, the image data producing unit 52 produces image data to display images to form the virtual image(s) 300 at a plurality of pixels corresponding to the display positions of the virtual image(s) 300. If the virtual image 300 to display is the virtual image 320 to be rendered stereoscopically, the image data producing unit 52 produces, based on the first image data and the position information provided by the rendering control unit 51, second image data to display the virtual image 320. On the other hand, if the virtual image 300 to display is the virtual image 310 to be rendered as a plane image, the image data producing unit 52 produces, based on the third image data and the position information provided by the rendering control unit 51, fourth image data to display the virtual image 310 (in S3).

When the image data producing unit 52 produces the image data (which may be the second image data and/or the fourth image data) to display the virtual image(s) 300, the output unit 53 outputs the image data to the display device 21.

On receiving the image data from the output unit 53, the display device 21 displays, on the display screen 211, image(s) to form the virtual image(s) 300 (namely, the virtual image 310 to be rendered as a plane image and/or the virtual image 320 to be rendered stereoscopically) (in S4).

The images displayed on the display screen 211 of the display device 21 are viewed by the user 200 who has a viewpoint inside the eye box 210 through the lens array 22 and the optical system 30. Thus, the virtual image 310 as the plane rendering target is viewed by the user 200 as if the virtual image 300 were projected onto the plane PL1 defined along the traveling surface 400 of the automobile 100. On the other hand, the virtual image 320 as the stereoscopic rendering target is viewed by the user 200 as if the virtual image 320 were displayed along the plane PL12 perpendicular to the traveling surface 400 of the automobile 100.

In this case, the virtual image 310 as the plane rendering target is rendered along the plane PL1, and therefore, may be displayed as a virtual image 310 that gives the user 200 a natural sense of distance. In addition, the user 200 views the images forming the virtual image 320 as the stereoscopic rendering target through the lens array 22. This allows the user 200 to view images reproducing the parallax between his or her eyes and to stereoscopically view the virtual image 320 displayed at a desired display position. In addition, the virtual image display system 10 also displays the virtual image 310 to be rendered as a plane image by having the third image data, stored in the storage unit 54, displayed as it is as fourth image data on the display screen 221. Therefore, the virtual image display system 10 has only to produce the second image data of the virtual image 320 as the stereoscopic rendering target. This may reduce the arithmetic processing load for producing the second image data for the virtual image 320 as the stereoscopic rendering target.

(3) Variation

Note that the embodiment described above is only an exemplary one of various embodiments of the present disclosure and should not be construed as limiting. Rather, the exemplary embodiment may be readily modified in various manners depending on a design choice or any other factor without departing from the scope of the present disclosure. Optionally, the functions of the virtual image display system 10 may also be implemented as, for example, a method for controlling the virtual image display system 10, a computer program, or a non-transitory storage medium on which a program is stored. An image display method according to an aspect is a method for displaying the image on the image display unit 20 of the virtual image display system 10. The image display method includes first, second, third, and fourth processing steps. The first processing step includes acquiring first image data of the stereoscopic rendering target (virtual image 320). The second processing step includes acquiring position information about a display position of the stereoscopic rendering target. The third processing step includes producing, based on the first image data and the position information, second image data to make the user view the stereoscopic rendering target stereoscopically. The fourth processing step includes displaying an image based on the second image data on the display screen 221 of the image display unit 20. A (computer) program according to another aspect is designed to cause one or more processors to perform the image display method.

Next, variations of the exemplary embodiment described above will be enumerated one after another. Note that the variations to be described below may be adopted in combination as appropriate. Also, in the following description, the exemplary embodiment described above will be hereinafter sometimes referred to as a “basic example.”

The virtual image display system 10 and head-up display 1 according to the present disclosure each include a computer system. The computer system may include a processor and a memory as principal hardware components thereof. The functions of the virtual image display system 10 and head-up display 1 according to the present disclosure may be performed by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be implemented as a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits include a system LSI, a very large-scale integrated circuit (VLSI), and an ultra large-scale integrated circuit (ULSI). Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be integrated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a largescale integrated circuit.

Also, in the embodiment described above, the plurality of constituent elements (or the functions) of the virtual image display system 10 are integrated together in a single housing 60. However, this is not an essential configuration for the virtual image display system 10. Alternatively, those constituent elements (or functions) of the virtual image display system 10 may be distributed in multiple different housings. Still alternatively, at least some functions of the virtual image display system 10 (e.g., some functions of the control unit 50 (such as the rendering control unit 51 and the image data producing unit 52)) may be implemented as, for example, a cloud computing system as well.

(3.1) First Variation

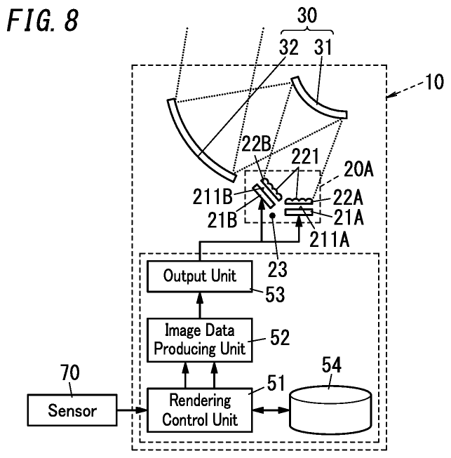

In the basic example, the image display unit 20 is implemented as a single display device 21. However, this is only an example of the present disclosure and should not be construed as limiting. Alternatively, an image display unit 20A may include a plurality of display devices 21A, 21B as shown in FIG. 8. The respective display screens 211A, 211B of the plurality of display devices 21A, 21B are tilted with respect to each other. In addition, the image display unit 20A further includes a lens array 22A arranged on the display screen 211A of the display device 21A and a lens array 22B arranged on the display screen 211B of the display device 21B. That is to say, the image display unit 20A further includes a plurality of lens arrays 22A, 22B arranged on the respective display screens 211A, 211B of the plurality of display devices 21A, 21B. Each of the plurality of lens arrays 22A, 22B has the same configuration as the lens array 22 described for the basic example. Each of the plurality of lens arrays 22A, 22B includes a plurality of lenses 222, which are arranged to form an array.

The display device 21A is tilted in the same direction with respect to the optical path L1 as the display device 21 that has been described for the basic example. Specifically, the display device 21A is arranged such that with respect to a focal point 23 of the optical system 30 made up of the first mirror 31 and the second mirror 32, a first interval between one end portion (i.e., the left end portion in FIG. 8) of the display screen 211A of the display device 21A and the focal point 23 becomes shorter than a second interval between the other end portion (i.e., the right end portion in FIG. 8) of the display screen 211A and the focal point 23. This allows the user 200 to view the plane rendered virtual image 310 based on the image displayed on the display screen 211A such that an upper part of the virtual image 310 appears to be present more distant than a lower part of the virtual image 310.

On the other hand, the display device 21B is arranged such that a first interval between one end portion (i.e., the lower end portion in FIG. 8) of the display screen 211B of the display device 21B and the focal point 23 becomes shorter than a second interval between the other end portion (i.e., the upper end portion in FIG. 8) of the display screen 211B and the focal point 23. This allows the user 200 to view the plane rendered virtual image 310 based on the image displayed on the display screen 211B such that a lower part of the virtual image 310 appears to be present more distant than an upper part of the virtual image 310.

Using a plurality of display devices 21A, 21B, of which the respective display screens 211A, 211B are tilted at mutually different angles, allows the virtual image 310, which is viewed by the user 200 based on the images displayed on the display devices 21A, 21B, to look differently, compared to a situation where only one display device 21 is provided.

Note that the image display unit 20A is supposed to be arranged between the optical system 30 and the focal point of the optical system 30. In the first variation, the image display unit 20A includes the two display devices 21A, 21B. Alternatively, the image display unit 20A may include three or more display devices. In addition, the plurality of display devices 21A, 21B included in the image display unit 20A do not have to be arranged as shown in FIG. 8. Rather, the arrangement of the plurality of display devices 21A, 21B may be changed as appropriate such that the image viewed by the user 200 is given a natural sense of distance.

(3.2) Other Variations

In the virtual image display system 10 according to the embodiment and variations described above, the optical system 30 only needs to project, into the eye box 210, a light beam that has come from the image display unit 20 and incident thereon by reflecting and/or refracting the light beam. Thus, the configuration of the optical system 30 may be changed as appropriate. For example, even though the first mirror 31 is a convex mirror in the embodiment described above, the first mirror 31 may also be a plane mirror or a concave mirror. Alternatively, the surface of the first mirror 31 may also be formed as a free-form surface to enable reducing the distortion of the image and increasing the resolution thereof. Furthermore, even though the second mirror 32 is a concave mirror in the embodiment described above, the second mirror 32 may also be a plane mirror or a convex mirror. The surface of the second mirror 32 may be formed as a free-form surface to enable reducing the distortion of the image and increasing the resolution thereof. Optionally, the optical system 30 may also be configured as one or more lenses, one or more mirrors, or a combination of one or more lenses and one or more mirrors.

In the virtual image display system 10 according to the exemplary embodiment and variations described above, the display device 21 is implemented as a display device such as a liquid crystal display or an organic electroluminescent (EL) display. However, the display device 21 does not have to be this type of display device. Alternatively, the display device 21 may also be configured to render an image on a diffusion-transmission type screen by scanning the screen with a laser beam radiated from behind the screen. Still alternatively, the display device 21 may also be configured to project an image onto a diffusion-transmission type screen from a projector arranged behind the screen.

The virtual image display system 10 according to the embodiment and variations described above is fixed in the moving vehicle body 110. However, the virtual image display system 10 according to the embodiment and variations is also applicable to a head mount display to be worn and used by the user 200 on the head or a display device in the shape of eyeglasses.

In the exemplary embodiment and variations described above, the virtual image display system 10 is applied to the automobile 100. However, this is only an example and should not be construed as limiting. The virtual image display system 10 is also applicable to two-wheeled vehicles, railway trains, aircrafts, construction machines, watercrafts, and various types of moving vehicles other than automobiles 100.

The virtual image display system 10 does not have to be implemented as a single device but may be made up of multiple devices as well. That is to say, the respective functions of the virtual image display system 10 may be performed dispersedly by two or more devices. For example, the functions of the control unit 50 of the virtual image display system 10 may be performed separately by an electronic control unit (ECU) of the automobile 100 or by a server device provided outside of the automobile 100. In that case, the image to be displayed on the image display unit 20 is produced by either the ECU or the server device.

(Recapitulation)

As can be seen from the foregoing description, a virtual image display system (10) according to a first aspect includes an image data producing unit (52), an image display (20), and an optical system (30). The image data producing unit (52) produces, based on image data of a rendering target and position information about a display position of the rendering target, image data to display a virtual image of the rendering target. The image display (20) displays, on a display screen (221), an image based on the image data to display the virtual image. The optical system (30) condenses, into an eye box (210), a light beam representing the image displayed on the display screen (221) and thereby makes a user, who has a viewpoint inside the eye box (210), view the virtual image (310) based on the image displayed on the display screen (221). The display screen (221) is arranged to be tilted with respect to an optical path (L1) leading from the display screen (221) to the optical system (30). The image data of the rendering target includes first image data of a stereoscopic rendering target. The image data producing unit (52) produces, based on the first image data included in the image data and position information about a display position of the stereoscopic rendering target, second image data to make the user view the stereoscopic rendering target stereoscopically.

According to this aspect, the display screen (221) is tilted with respect to an optical path (L1) that leads from the display screen (221) to the optical system (30), thus making the distance between the eye box (210) and the display screen (221) variable within the plane of the display screen (221). This allows providing a virtual image display system (10) which may give a natural sense of distance to the virtual image (310) viewed by the user (200) based on the image displayed on the display screen (221) and thereby contributes to increasing the degree of visibility thereof.

In a virtual image display system (10) according to a second aspect, which may be implemented in conjunction with the first aspect, the image data of the rendering target further includes third image data of a plane rendering target. The image data producing unit (52) further produces, based on the third image data and position information about a display position of the plane rendering target, fourth image data to make plane rendering of the plane rendering target. The image display (20) displays, on the display screen (221), an image based on the fourth image data.

This aspect allows providing a virtual image display system (10) which contributes to increasing the degree of visibility.

In a virtual image display system (10) according to a third aspect, which may be implemented in conjunction with the first or second aspect, the stereoscopic rendering target includes a first target and a second target. The first target is a target, of which a display position remains located at a predetermined distance from the eye box (210) irrespective of surrounding circumstances. The second target is a target, of which a display position is located at a distance, varying according to the surrounding circumstances, from the eye box (210).

This aspect allows providing a virtual image display system (10) which contributes to increasing the degree of visibility.

In a virtual image display system (10) according to a fourth aspect, which may be implemented in conjunction with the third aspect, the distance from the display position of the second target to the eye box (210) varies according to a result of measurement made by a sensor to measure surrounding circumstances.

This aspect allows providing a virtual image display system (10) which contributes to increasing the degree of visibility.

In a virtual image display system (10) according to a fifth aspect, which may be implemented in conjunction with any one of the first to fourth aspects, the image display (20) includes a display device (21) and a lens array (22). The lens array (22) includes a plurality of lenses (222) that are arranged to form an array and is provided on the display screen (221) of the display device (21).

This aspect allows providing a virtual image display system (10) which contributes to increasing the degree of visibility.

In a virtual image display system (10) according to a sixth aspect, which may be implemented in conjunction with any one of the first to fourth aspects, the image display (20) includes a plurality of display devices (21A, 21B). The respective display screens (211A, 211B) of the plurality of display devices (21A, 21B) are tilted with respect to each other.

This aspect allows providing a virtual image display system (10) which contributes to increasing the degree of visibility.

In a virtual image display system (10) according to a seventh aspect, which may be implemented in conjunction with the sixth aspect, the image display (20) further includes a plurality of lens arrays (22A, 22B), each of which is provided on the display screen (211A, 211B) of an associated one of the plurality of display devices (21A, 21B). Each of the plurality of lens arrays (22A, 22B) includes a plurality of lenses (222) arranged to form an array.

This aspect allows providing a virtual image display system (10) which contributes to increasing the degree of visibility.

An image display method according to an eighth aspect is a method for displaying the image on the image display (20) of the virtual image display system (10) according to any one of the first to seventh aspects. The image display method includes first, second, third, and fourth processing steps. The first processing step includes acquiring first image data of the stereoscopic rendering target. The second processing step includes acquiring position information about a display position of the stereoscopic rendering target. The third processing step includes producing, based on the first image data and the position information, second image data to make the user view the stereoscopic rendering target stereoscopically. The fourth processing step includes displaying an image based on the second image data on the display screen (221) of the image display (20).

This aspect contributes to increasing the degree of visibility.

A head-up display (1) according to a ninth aspect includes the virtual image display system (10) according to any one of the first to seventh aspects. The optical system (30) includes a reflective member (112) having a light-transmitting property and configured to reflect incident light toward the eye box (210). The head-up display (1) makes a user, who has a viewpoint (201) inside the eye box (210), view the virtual image (310) superimposed on a real space, which is seen by the user through the reflective member (112).

This aspect allows providing a head-up display (1) which contributes to increasing the degree of visibility.

A moving vehicle (100) according to a tenth aspect includes a moving vehicle body (110) that moves; and the head-up display (1) according to the ninth aspect. The head-up display (1) is installed in the moving vehicle body (110). The reflective member (112) includes a windshield (112) or combiner of the moving vehicle body (110).

This aspect allows providing a moving vehicle (100) including a virtual image display system (10) which contributes to increasing the degree of visibility.

Note that these are not the only aspects of the present disclosure. Rather, various configurations of the virtual image display system (10) according to the exemplary embodiment described above (including variations thereof) may also be implemented as an image display method using the virtual image display system (10), a (computer) program, or a non-transitory storage medium that stores a program thereon, for example.

Note that the constituent elements according to the second to eighth aspects are not essential constituent elements for the virtual image display system (10) but may be omitted as appropriate.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A virtual image display system comprising:
an image data producing unit that produces, based on image data of a rendering target and position information about a display position of the rendering target, image data to display a virtual image of the rendering target;
an image display that displays, on a display screen, an image based on the image data to display the virtual image; and
an optical system that condenses, into an eye box, a light beam representing the image displayed on the display screen and thereby makes a user, who has a viewpoint inside the eye box, view the virtual image based on the image displayed on the display screen, wherein
the display screen is arranged to be tilted with respect to an optical path leading from the display screen to the optical system,
the image data of the rendering target includes first image data of a stereoscopic rendering target, and
the image data producing unit produces, based on the first image data included in the image data and position information about a display position of the stereoscopic rendering target, second image data to make the user view the stereoscopic rendering target stereoscopically.

2. The virtual image display system of claim 1, wherein
the image data of the rendering target further includes third image data of a plane rendering target,
the image data producing unit further produces, based on the third image data and position information about a display position of the plane rendering target, fourth image data to make plane rendering of the plane rendering target, and
the image display displays, on the display screen, an image based on the fourth image data.

3. The virtual image display system of claim 1, wherein
the stereoscopic rendering target includes:
a first target, of which a display position remains located at a predetermined distance from the eye box irrespective of surrounding circumstances; and
a second target, of which a display position is located at a distance, varying according to the surrounding circumstances, from the eye box.

4. The virtual image display system of claim 3, wherein
the distance from the display position of the second target to the eye box varies according to a result of measurement made by a sensor that measures the surrounding circumstances.

5. The virtual image display system of claim 1, wherein
the image display includes: a display device; and a lens array including a plurality of lenses that are arranged to form an array, the lens array being provided on the display screen of the display device.

6. The virtual image display system of claim 1, wherein
the image display includes a plurality of display devices, and
the respective display screens of the plurality of display devices are tilted with respect to each other.

7. The virtual image display system of claim 6, wherein
the image display further includes a plurality of lens arrays, each of which is provided on the display screen of an associated one of the plurality of display devices, and
each of the plurality of lens arrays includes a plurality of lenses arranged to form an array.

8. An image display method for displaying the image on the image display of the virtual image display system of claim 1, the image display method comprising:
acquiring first image data of the stereoscopic rendering target;
acquiring position information about a display position of the stereoscopic rendering target;
producing, based on the first image data and the position information, second image data to make the user view the stereoscopic rendering target stereoscopically; and
displaying an image based on the second image data on the display screen of the image display.

9. A head-up display comprising the virtual image display system of claim 1,
the optical system including a reflective member having a light-transmitting property and reflecting incident light toward the eye box,
the head-up display making a user, who has a viewpoint inside the eye box, view the virtual image superimposed on a real space, the real space being seen by the user through the reflective member.

10. A moving vehicle comprising:
a moving vehicle body that moves; and
the head-up display of claim 9 installed in the moving vehicle body,
the reflective member including a windshield or combiner of the moving vehicle body.

11. The virtual image display system of claim 2, wherein
the stereoscopic rendering target includes:
a first target, of which a display position remains located at a predetermined distance from the eye box irrespective of surrounding circumstances; and
a second target, of which a display position is located at a distance, varying according to the surrounding circumstances, from the eye box.

12. The virtual image display system of claim 11, wherein
the distance from the display position of the second target to the eye box varies according to a result of measurement made by a sensor that measures the surrounding circumstances.

13. The virtual image display system of claim 2, wherein
the image display includes: a display device; and a lens array including a plurality of lenses that are arranged to form an array, the lens array being provided on the display screen of the display device.

14. The virtual image display system of claim 3, wherein
the image display includes: a display device; and a lens array including a plurality of lenses that are arranged to form an array, the lens array being provided on the display screen of the display device.

15. The virtual image display system of claim 4, wherein
the image display includes: a display device; and a lens array including a plurality of lenses that are arranged to form an array, the lens array being provided on the display screen of the display device.

16. The virtual image display system of claim 11, wherein
the image display includes: a display device; and a lens array including a plurality of lenses that are arranged to form an array, the lens array being provided on the display screen of the display device.

17. The virtual image display system of claim 12, wherein
the image display includes: a display device; and a lens array including a plurality of lenses that are arranged to form an array, the lens array being provided on the display screen of the display device.

18. The virtual image display system of claim 2, wherein
the image display includes a plurality of display devices, and
the respective display screens of the plurality of display devices are tilted with respect to each other.

19. The virtual image display system of claim 3, wherein
the image display includes a plurality of display devices, and
the respective display screens of the plurality of display devices are tilted with respect to each other.

20. The virtual image display system of claim 4, wherein
the image display includes a plurality of display devices, and
the respective display screens of the plurality of display devices are tilted with respect to each other.
